(19) United States
(12) Patent Application Publication
(10) Pub. No.: US 2026/0180151 A1
(43) Pub. Date: Jun. 25, 2026

(54) ENERGY STORAGE MODULE AND METHOD FOR INSPECTING ENERGY STORAGE MODULE

(71) Applicant: TOYOTA JIDOSHA KABUSHIKI KAISHA, Toyota-shi (JP)

(72) Inventors: Kouta MARUYAMA, Nukata-gun (JP); Kazuhito Kato, Toyota-shi (JP); Takeshi Arikawa, Toyota-shi (JP); Takashi Fukuda, Kariya-shi (JP); Satoshi Hamaoka, Kariya-shi (JP); Shinya Kimura, Kariya-shi (JP); Fumihiko Ishiguro, Kariya-shi (JP); Takayuki Hirose, Kariya-shi (JP)

(21) Appl. No.: 19/380,972

(22) Filed: Nov. 6, 2025

(30) Foreign Application Priority Data
Dec. 25, 2024 (JP) 2024-229041

(51) Int. Cl. H01M 50/627; G01M 3/04; G01M 3/26; H01M 4/02; H01M 50/184; H01M 50/46

(52) U.S. Cl. CPC H01M 50/627; G01M 3/04; G01M 3/26; H01M 50/184; H01M 50/46; H01M 2004/029

(57) ABSTRACT

An energy storage module includes: a plurality of bipolar electrode stacks; a plurality of frame-shaped sealing portions; and an injection connector. The energy storage module includes a plurality of electrolyte chambers, each provided by a corresponding pair of the bipolar electrode stacks adjacent to each other in a stacking direction of the bipolar electrode stacks and the frame-shaped sealing portion interposed between the pair of bipolar electrode stacks. Each of the electrolyte chambers has an injection hole provided in a respective one of the frame-shaped sealing portions. The injection holes are arranged in an array of a plurality of rows in the stacking direction and a plurality of columns in an in-plane direction.

### CROSS-REFERENCE TO RELATED APPLICATION

This application claims priority to Japanese Patent Application No. 2024-229041 filed on Dec. 25, 2024. The disclosure of the above-identified application, including the specification, drawings, and claims, is incorporated by reference herein in its entirety.

### BACKGROUND

### 1. Technical Field

The present disclosure relates to energy storage modules and methods for inspecting an energy storage module.

### 2. Description of Related Art

Bipolar batteries are attracting attention because they can connect multiple cells in series without requiring connection parts such as busbars or current collector terminals. An energy storage module of a bipolar battery has a plurality of electrolyte chambers into which an electrolyte is injected. To prevent a liquid short-circuit between electrodes, it is desired to seal each electrolyte chamber, and various sealing inspection methods have been proposed. In the present specification, the term “electrolyte” refers to an electrolyte solution unless otherwise specified.

Japanese Unexamined Patent Application Publication No. 2020-035664 (JP 2020-035664 A) discloses a method for inspecting an energy storage module including: a stack of electrodes; and a sealing body that surrounds the side surface of the electrode stack, forms a plurality of internal spaces between adjacent electrodes, and seals the internal spaces. The method includes: a first step of simultaneously changing the internal pressure of a first group of the internal spaces, which corresponds to the odd-numbered or even-numbered spaces counted from one end in the stacking direction of the electrode stack among the plurality of internal spaces arranged along the stacking direction of the electrode stack; and a second step of detecting the presence or absence of a change in internal pressure in a second group of the internal spaces, which are the internal spaces whose internal pressure was not changed in the first step. JP 2020-035664 A describes that the disclosed method enables simple and rapid sealing inspection of internal spaces in an energy storage module.

Japanese Unexamined Patent Application Publication No. 2018-170265 (JP 2018-170265 A) discloses a method for inspecting an energy storage module including: a stack of a plurality of bipolar electrodes each including an electrode plate, a cathode provided on one surface of the electrode plate, and an anode provided on the other surface of the electrode plate; and a frame that holds the edges of the electrode plates at the side surface of the stack extending in the stacking direction of the bipolar electrodes. The method includes: a preparation step of preparing the energy storage module; and an inspection step of inspecting airtightness of the energy storage module. In the energy storage module prepared in the preparation step, the frame is provided with at least a first injection port and a second injection port for injecting an electrolyte into the inside of the frame. The frame includes a plurality of first resin portions that holds the edges of the electrode plates, and a second resin portion provided around the first resin portions as viewed in the stacking direction. The first injection port has a first opening provided in any one of the first resin portions and a second opening provided in the second resin portion. The first opening is in communication with the internal space of the energy storage module and the second opening. The second injection port has a third opening provided in a different one of the first resin portions from the first resin portion in which the first opening is provided, and a fourth opening provided in the second resin portion at a position different from that of the second opening. The third opening is in communication with the internal space of the energy storage module and the fourth opening. In the energy storage module, a portion of the internal space that is in communication with the first injection port and a portion of the internal space that is in communication with the second injection port are sealed from each other. In the inspection step, airtightness of the energy storage module is inspected based on a change in thickness of the energy storage module caused by entry of fluid through the first and second injection ports. JP 2018-170265 A describes that the disclosed method facilitates inspection of airtightness of an energy storage module.

Japanese Unexamined Patent Application Publication No. 2020-145030 (JP 2020-145030 A) discloses a method for manufacturing an energy storage module including: an electrode stack including a plurality of electrodes stacked in a first direction; and a seal member surrounding the electrode stack as viewed in the first direction. The electrodes include a bipolar electrode including an electrode plate, a cathode provided on one surface of the electrode plate, and an anode provided on the other surface of the electrode plate. The seal member includes a first resin portion having a first communication hole that is in communication with an internal space provided between adjacent electrodes, and a second resin portion having a second communication hole that is in communication with the first communication hole. The method includes: a first molding step of attaching, to a mold, a first insert having a first-communication-hole forming portion for forming the first communication hole, and forming the first resin portion by resin molding using the mold; and a second molding step of attaching, to the mold, a second insert having a second-communication-hole forming portion for forming the second communication hole, and forming the second resin portion by resin molding using the mold. In the second molding step, the second-communication-hole forming portion is inserted into the first communication hole to a position where it does not pass through the first communication hole, and resin molding of the second resin portion is performed. JP 2020-145030 A describes the disclosed method enables smooth manufacturing of an energy storage module.

### SUMMARY

There is a demand for reducing the workload of the sealing inspection of the electrolyte chambers in an energy storage module of a bipolar battery. The inspection items for the sealing inspection include a leak inspection between adjacent electrolyte chambers (inter-chamber leak inspection) and a leak inspection inside an injection connector (injection-connector leak inspection).

The method disclosed in JP 2020-035664 A can reduce the workload of the inter-chamber leak inspection. However, there is a demand for reducing the workload of the sealing inspection that includes not only the inter-chamber leak inspection but also the injection-connector leak inspection.

Therefore, an object of the present disclosure is to provide an energy storage module that enables rapid sealing inspection of electrolyte chambers.

The present disclosure achieves the above object by the following means.

### First Aspect

An energy storage module including: a plurality of bipolar electrode stacks; a plurality of frame-shaped sealing portions; and an injection connector, wherein:
the energy storage module includes a plurality of electrolyte chambers, each provided by a corresponding pair of the bipolar electrode stacks adjacent to each other in a stacking direction of the bipolar electrode stacks and the frame-shaped sealing portion interposed between the pair of bipolar electrode stacks;
each of the electrolyte chambers has an injection hole provided in a respective one of the frame-shaped sealing portions;
the injection holes are arranged in an array of a plurality of rows in the stacking direction and a plurality of columns in an in-plane direction, and each of the injection holes is in communication with a respective one of a plurality of injection flow paths of the injection connector; and
for the m-th electrolyte chamber and the n-th electrolyte chamber counted from the lower side in the stacking direction, there is at least one combination of m and n that satisfies the following conditions:
(i) the injection hole of the n-th electrolyte chamber is disposed adjacent to the upper side, in the stacking direction, of the injection hole of the m-th electrolyte chamber; and
(ii) when m is odd, n is even, and when m is even, n is odd.

### Second Aspect

The energy storage module according to the first aspect, wherein, for the p-th electrolyte chamber and the q-th electrolyte chamber counted from the lower side in the stacking direction of the bipolar electrode stacks, there is at least one combination of p and q that satisfies the following conditions:
(i) the injection hole of the p-th electrolyte chamber is disposed adjacent to the left side, in the in-plane direction, of the injection hole of the q-th electrolyte chamber; and
(ii) when p is odd, q is even, and when p is even, q is odd.

### Third Aspect

The energy storage module according to the first or second aspect, wherein the number of columns of the injection holes arranged in the in-plane direction is even.

### Fourth Aspect

A method for inspecting the energy storage module according to any one of the first to third aspects, the method including:
setting an odd-numbered electrolyte chamber and an even-numbered electrolyte chamber counted from the lower side in the stacking direction of the bipolar electrode stacks to different internal pressures; and
detecting either or both of entry of gas or liquid in the even-numbered electrolyte chamber into one or more of the odd-numbered electrolyte chambers and entry of gas or liquid in the odd-numbered electrolyte chamber into one or more of the even-numbered electrolyte chambers.

### Fifth Aspect

In the energy storage module according to the fourth aspect, wherein, when the entry is detected, determination is made that there is an abnormality in at least one of sealing between adjacent ones of the electrolyte chambers, sealing between adjacent ones of the injection flow paths of the injection connector, or sealing between the injection connector and the frame-shaped sealing portion.

The present disclosure provides an energy storage module that enables rapid sealing inspection of electrolyte chambers.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an energy storage module of the present disclosure;

FIG. 2 is a schematic diagram illustrating the energy storage module of the present disclosure;

FIG. 3 is a schematic diagram illustrating the energy storage module of the present disclosure;

FIG. 4A is a schematic diagram illustrating the energy storage module of the present disclosure;

FIG. 4B is a schematic diagram illustrating the energy storage module of the present disclosure;

FIG. 4C is a schematic diagram illustrating the energy storage module of the present disclosure;

FIG. 4D is a schematic diagram illustrating the energy storage module of the present disclosure;

FIG. 4E is a schematic diagram illustrating the energy storage module of the present disclosure;

FIG. 4F is a schematic diagram illustrating the energy storage module of the present disclosure; and

FIG. 4G is a schematic diagram illustrating the energy storage module of the present disclosure.

### DETAILED DESCRIPTION OF EMBODIMENTS

Hereinafter, an embodiment of the present disclosure will be described in detail. The present disclosure is not limited to the following embodiment, and various modifications may be made without departing from the scope of the present disclosure. The same elements are denoted by the same signs throughout the drawings, and description thereof will not be repeated.

### Energy Storage Module

An energy storage module of the present disclosure is an energy storage module including: a plurality of bipolar electrode stacks; a plurality of frame-shaped sealing portions; and an injection connector.

The energy storage module includes a plurality of electrolyte chambers, each provided by a corresponding pair of the bipolar electrode stacks adjacent to each other in the stacking direction of the bipolar electrode stacks and the frame-shaped sealing portion interposed between the pair of bipolar electrode stacks.
Each of the electrolyte chambers has an injection hole provided in a respective one of the frame-shaped sealing portions.
The injection holes are arranged in an array of a plurality of rows in the stacking direction and a plurality of columns in an in-plane direction, and each of the injection holes is in communication with a respective one of a plurality of injection flow paths of the injection connector.
For the m-th electrolyte chamber and the n-th electrolyte chamber counted from the lower side in the stacking direction, there is at least one combination of m and n that satisfies the following conditions:
(i) the injection hole of the n-th electrolyte chamber is disposed adjacent to the upper side, in the stacking direction, of the injection hole of the m-th electrolyte chamber; and
(ii) when m is odd, n is even, and when m is even, n is odd.

The present disclosure thus provides an energy storage module that enables rapid sealing inspection of electrolyte chambers.

In the present specification, the term “sealing inspection” refers to an inspection for confirming, when the electrolyte chambers are filled with an electrolyte, that there is no leakage of the electrolyte into other electrolyte chambers. If leakage into other electrolyte chambers occurs, a liquid short-circuit may occur, which may cause failure of the energy storage module. Examples of leakage into other electrolyte chambers include inter-chamber leak and injection-connector leak.

When inter-chamber leak inspection of the energy storage module is performed using the inspection method disclosed in JP 2020-035664 A, it is possible to perform the inter-chamber leak inspection in a single step.

On the other hand, when injection-connector leak inspection is to be performed in addition to inter-chamber leak inspection using the inspection method of JP 2020-035664 A, it may be necessary to add a separate step for injection-connector leak inspection.

The inventors have found that both inter-chamber leak inspection and injection-connector leak inspection can be performed in a single step when the energy storage module satisfies the following conditions: the injection hole of the n-th electrolyte chamber is disposed adjacent to the upper side, in the stacking direction, of the injection hole of the m-th electrolyte chamber; and when m is odd, n is even, and when m is even, n is odd.

In the present specification, the term “x-th electrolyte chamber” refers to the x-th cell counted from the lowermost electrolyte chamber in the stacking direction. Here, “x” represents any natural number that does not exceed the number of electrolyte chambers included in the energy storage module.

In the present specification, the “stacking direction” refers to the direction in which the bipolar electrode stacks are stacked. The “lower side in the stacking direction” refers to the cathode terminal stack side in the stacking direction, and the “upper side in the stacking direction” refers to the anode terminal stack side in the stacking direction.

In the present specification, the “in-plane direction” refers to any direction in a plane perpendicular to the stacking direction. The “left side in the in-plane direction” refers to the left side, in the in-plane direction, of the side surface of the energy storage module when the side surface is viewed from the front, and the “right side in the in-plane direction” refers to the right side, in the in-plane direction, of the side surface of the energy storage module when the side surface is viewed from the front.

The energy storage module of the present disclosure includes the bipolar electrode stacks, the frame-shaped sealing portions, and the injection connector. The energy storage module may be applied to a lithium-ion secondary cell.

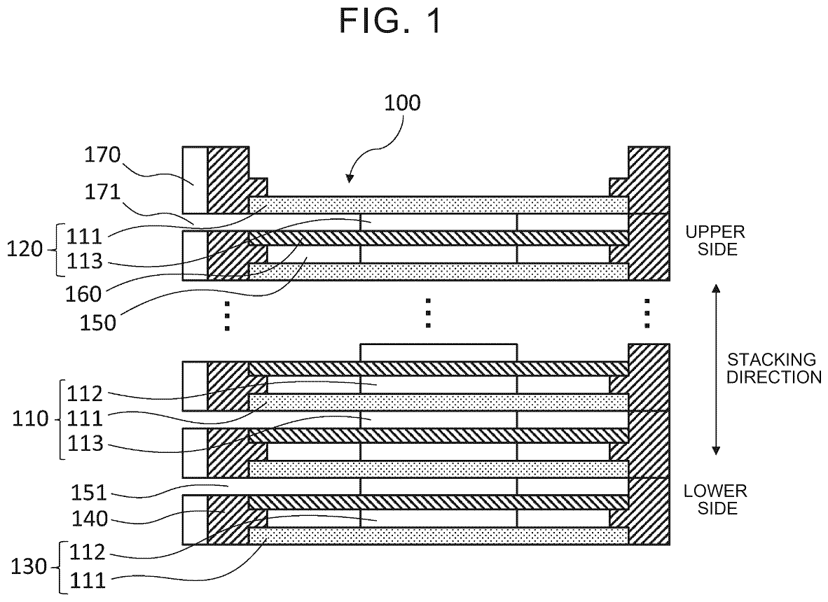

FIG. 1 is a schematic diagram showing one embodiment of the energy storage module of the present disclosure. However, the present disclosure is not limited to this.

For example, as shown in FIG. 1, an energy storage module 100 includes a plurality of bipolar electrode stacks 110 and a plurality of frame-shaped sealing portions 140, and has a rectangular shape as viewed in the stacking direction.

Each bipolar electrode stack 110 includes a current collector layer 111, a cathode active material layer 112, and an anode active material layer 113. The cathode active material layer 112 is formed on one side of the current collector layer 111, and the anode active material layer 113 is formed on the opposite side of the current collector layer 111. The cathode active material layer 112 of each bipolar electrode stack 110 is adjacent to the anode active material layer 113 of an adjacent bipolar electrode stack 110 in the stacking direction with a separator 160 interposed therebetween. The anode active material layer 113 of each bipolar electrode stack 110 is adjacent to the cathode active material layer 112 of an adjacent bipolar electrode stack 110 in the stacking direction with a separator 160 interposed therebetween.

The energy storage module 100 includes an anode terminal stack 120 at one end in the stacking direction, and a cathode terminal stack 130 at the opposite end. The anode terminal stack 120 includes a current collector layer 111 and an anode active material layer 113. The anode active material layer 113 of the anode terminal stack 120 is adjacent to the cathode active material layer 112 in the stacking direction with a separator 160 interposed therebetween. The cathode terminal stack 130 includes a current collector layer 111 and a cathode active material layer 112. The cathode active material layer 112 of the cathode terminal stack 130 is adjacent to the anode active material layer 113 in the stacking direction with a separator 160 interposed therebetween.

Each of the frame-shaped sealing portions 140 is disposed in a frame shape along the periphery of a corresponding one of the current collector layers 111 of the bipolar electrode stacks 110, the anode terminal stack 120, and the cathode terminal stack 130. An injection connector 170 is attached to a part of the frame-shaped sealing portion 140.

### Frame-Shaped Sealing Portion

The frame-shaped sealing portion may be disposed in a frame shape along the peripheral edge on the current collector layer of the bipolar electrode stack. The frame-shaped sealing portion may be welded and joined in an airtight manner to the bipolar electrode stack by ultrasonic welding or heat.

The material of the frame-shaped sealing portion is not particularly limited, and may be, for example, a material having insulating properties and resistance to electrolytes. Examples of the material include porous films such as polyethylene (PE) or polypropylene (PP), and woven fabrics or nonwoven fabrics made of, for example, polypropylene or methylcellulose.

The dimensions of the frame-shaped sealing portion are not particularly limited, and may be determined as appropriate according to, for example, the desired strength of the energy storage module or the desired sealing performance.

### Injection Connector

The material of the injection connector is not particularly limited, and may be, for example, a material having insulating properties and resistance to electrolytes. The material of the injection connector may be a resin such as polyethylene (PE) or polypropylene (PP).

The dimensions of the injection connector are not particularly limited, and may be determined as appropriate according to, for example, the dimensions of the energy storage module or the dimensions of the injection holes. The injection connector may be formed as a single piece or may be divided into a plurality of pieces.

The energy storage module of the present disclosure includes a plurality of electrolyte chambers, each formed by a corresponding pair of bipolar electrode stacks adjacent to each other in the stacking direction and the frame-shaped sealing portion interposed between the pair of bipolar electrode stacks.

For example, as shown in FIG. 1, the energy storage module 100 includes a plurality of electrolyte chambers 150, each formed by a corresponding pair of bipolar electrode stacks 110 adjacent to each other in the stacking direction and the frame-shaped sealing portion 140 interposed therebetween. That is, the energy storage module 100 can be said to be formed by the stacked electrolyte chambers 150. The interior of each electrolyte chamber 150 is partitioned by a corresponding one of the separators 160. The uppermost electrolyte chamber 150 is formed by the anode terminal stack 120, the bipolar electrode stack 110 adjacent to the anode terminal stack 120 in the stacking direction, and the frame-shaped sealing portion 140. The lowermost electrolyte chamber 150 is formed by the cathode terminal stack 130, the bipolar electrode stack 110 adjacent to the cathode terminal stack 130 in the stacking direction, and the frame-shaped sealing portion 140.

### Electrolyte Chamber

Each electrolyte chamber has an injection hole formed in a corresponding sealing portion. The interior of each electrolyte chamber may be filled with an electrolyte.

For example, as shown in FIG. 1, each electrolyte chamber 150 has an injection hole 151 formed by penetrating the sealing portion.

The shape of the injection holes is not particularly limited, and may be, for example, rectangular. After filling with the electrolyte, the injection holes may be sealed with a sealing material etc.

The injection holes are arranged in an array of multiple rows in the stacking direction and multiple columns in the in-plane direction, and each of the injection holes is in communication with a respective one of a plurality of injection flow paths of the injection connector.

For the m-th and n-th electrolyte chambers counted from the lower side in the stacking direction, there is at least one combination of m and n that satisfies the following conditions:
(i) the injection hole of the n-th electrolyte chamber is disposed adjacent to the upper side, in the stacking direction, of the injection hole of the m-th electrolyte chamber; and
(ii) when m is odd, n is even, and when m is even, n is odd.

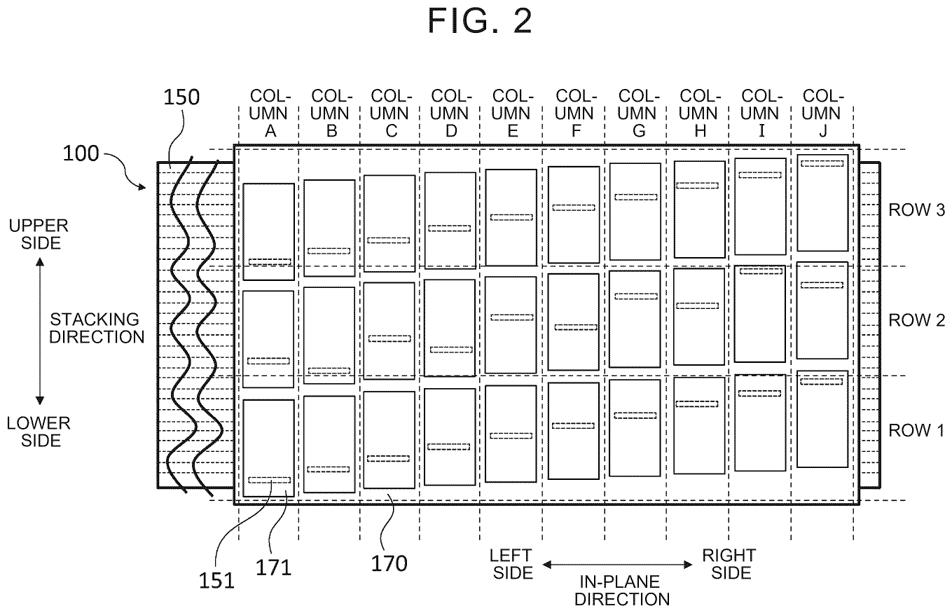

FIG. 2 is a schematic diagram of one embodiment of the energy storage module of the present disclosure. However, the present disclosure is not limited to this.

For example, as shown in FIG. 2, each of the first to thirtieth electrolyte chambers 150 of the energy storage module 100 has an injection hole 151 positioned at one of 10 positions corresponding to columns A to J in the in-plane direction. For example, each of the first, twelfth, and twenty-first electrolyte chambers 150 has an injection hole 151 located at a position in column A. These three injection holes 151 are connected to an injection flow path 171 provided in the injection connector 170, and the electrolyte can be injected into the electrolyte chambers 150 through the injection flow path 171. Similarly, the injection holes 151 located at positions in columns B to J are each connected to a respective injection flow path 171 provided in the injection connector 170.

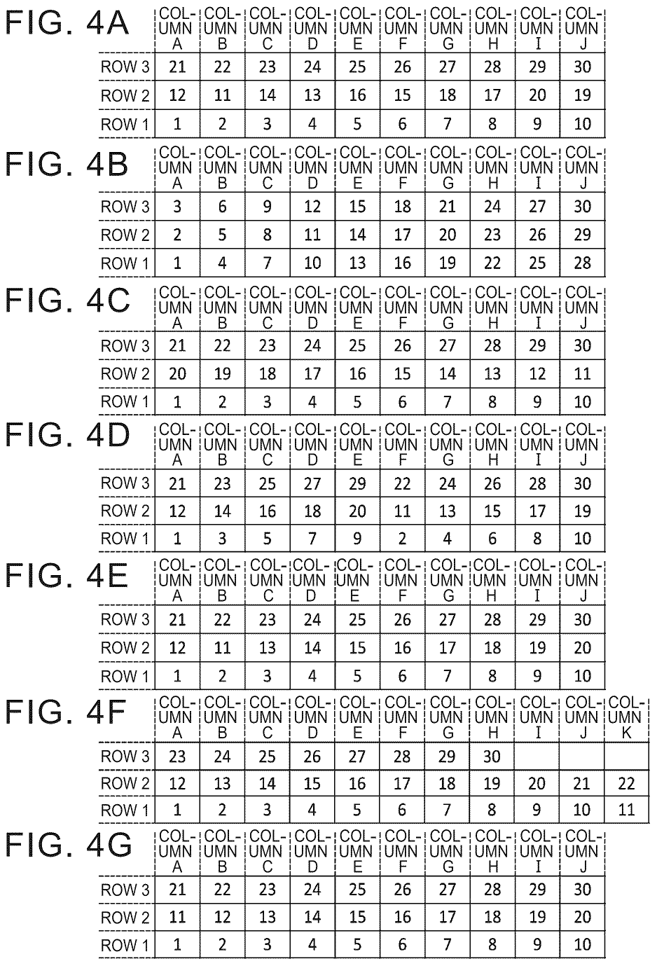

In the present specification, the positional relationship between each electrolyte chamber 150 and the injection hole 151 of each electrolyte chamber 150 in the energy storage module 100 is expressed by tables such as those shown in FIGS. 4A, 4B, 4C, 4D, 4E, 4F, and 4G. One cell in each table corresponds to one injection hole 151. The number written in each cell indicates that the injection hole 151 is the injection hole 151 of the (that-number)-th electrolyte chamber 150. Rows 1 to 3 indicate the positional relationship of the injection holes 151 in the stacking direction, and columns A to J indicate the positions of the injection holes 151 in the in-plane direction. For example, the energy storage module 100 of FIG. 2 corresponds to FIG. 4A. In FIG. 4A, “1” means that the injection hole 151 of the first electrolyte chamber 150 is provided at a position in column A, and that the injection hole 151 of the first electrolyte chamber 150 located in row 1 of column A is adjacent in the stacking direction to the injection hole 151 of the twelfth electrolyte chamber 150 located in row 2 of the same column A. Inter-chamber leak may occur between two consecutively numbered electrolyte chambers 150, while injection-connector leak may occur between electrolyte chambers 150 adjacent to each other in the stacking direction. For example, in FIG. 4A, inter-chamber leak may occur between the first electrolyte chamber 150 (“1”) and the second electrolyte chamber 150 (“2”), and injection-connector leak may occur between the first electrolyte chamber 150 (“1”) and the twelfth electrolyte chamber 150 (“12”).

Therefore, by, for example, simultaneously pressurizing the odd-numbered electrolyte chambers 150 and simultaneously detecting pressure changes in the even-numbered electrolyte chambers 150, both inter-chamber leak inspection and injection-connector leak inspection can be performed in a single step.

Taking FIG. 1 as an example, the term “Inter-chamber leak” refers to leakage of the electrolyte that occurs between adjacent electrolyte chambers 150 when an abnormality such as a crack occurs in the bipolar electrode stack 110.

Taking FIG. 2 as an example, the term “injection-connector leak” refers to leakage of the electrolyte that may occur between electrolyte chambers 150 with adjacent injection holes 151 in the stacking direction, for example, between the first and twelfth electrolyte chambers 150, via the interior of the injection connector 170 when an abnormality such as a crack occurs in the injection connector 170.

Regarding the positional relationship between the electrolyte chambers constituting the energy storage module and the injection holes of the electrolyte chambers, it is sufficient that there is at least one such combination of m and n as described above. For example, the positional relationship may be as shown in FIGS. 4B, 4C, 4D, 4E, or 4F. In the case of FIG. 4E, injection-connector leak inspection is possible between the first and twelfth electrolyte chambers (“1” and “12”), between the twelfth and twenty-first electrolyte chambers (“12” and “21”), between the second and eleventh electrolyte chambers (“2” and “11”), and between the eleventh and twenty-second electrolyte chambers (“11” and “22”).

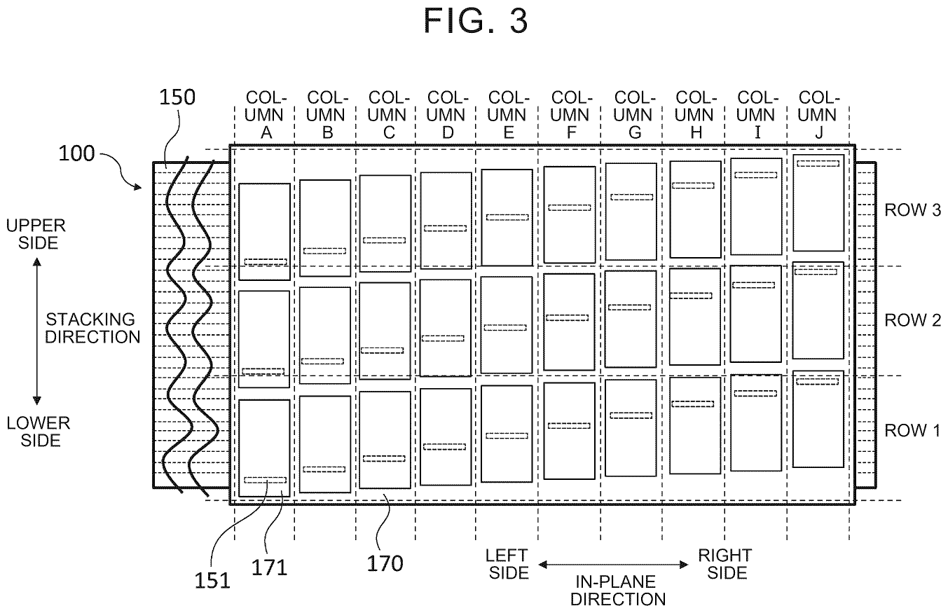

On the other hand, in the positional relationship shown in FIG. 4G corresponding to FIG. 3, since there is no such combination of m and n, both inter-chamber leak inspection and injection-connector leak inspection cannot be performed in a single step.

For the p-th and q-th electrolyte chambers counted from the lower side in the stacking direction of the bipolar electrode stacks, there may also be at least one combination of p and q that satisfies the following conditions:
(i) the injection hole of the p-th electrolyte chamber is disposed adjacent to the left side, in the in-plane direction, of the injection hole of the q-th electrolyte chamber; and
(ii) when p is odd, q is even, and when p is even, q is odd.

When there is at least one such combination of p and q in addition to the above combination of m and n, it becomes possible to perform not only inter-chamber leak inspection and injection-connector leak inspection in a single step, but also detection of injection-connector leak between electrolyte chambers adjacent to each other in the in-plane direction. This can be achieved by, for example, simultaneously pressurizing the odd-numbered electrolyte chambers and simultaneously detecting pressure changes in the even-numbered electrolyte chambers. For example, in the positional relationships shown in FIGS. 4A, 4B, 4C, 4D, 4E, and 4F, there is at least one such combination of p and q. In the case of FIG. 4D, injection-connector leak inspection between electrolyte chambers 150 adjacent to each other in the row direction is possible between the second and ninth electrolyte chambers (“2” and “9”), between the eleventh and twentieth electrolyte chambers (“11” and “20”), and between the twenty-second and twenty-ninth electrolyte chambers (“22” and “29”). In the case of FIG. 4E, injection-connector leak inspection between electrolyte chambers 150 adjacent to each other in the row direction is possible except between the eleventh and thirteenth electrode chambers (“11” and “13”).

The number of columns of the injection holes arranged in the in-plane direction may be even. When the number of columns is even, the positional relationship may be, for example, as shown in FIGS. 4A, 4B, 4C, 4D, or 4E. When the number of columns is odd, the positional relationship may be, for example, as shown in FIG. 4F. As in FIG. 4F, the number of injection holes in each column may not be the same.

The number of rows of the injection holes arranged in the stacking direction is not particularly limited, and may be, for example, three. As in FIG. 4G, the number of injection holes in each row may not be the same.

The interior of the electrolyte chamber may be partitioned by a separator configured to reduce the likelihood of contact between the cathode and the anode.

### Electrolyte

The electrolyte is not particularly limited, and may contain, for example, lithium ions as carrier ions. The electrolyte may be, for example, a non-aqueous electrolyte. The electrolyte may be, for example, a carbonate-based solvent in which a lithium salt is dissolved at a predetermined concentration. Examples of carbonate-based solvents include fluoroethylene carbonate (FEC), ethylene carbonate (EC), and dimethyl carbonate (DMC). Examples of the lithium salt include lithium hexafluorophosphate.

### Separator

The separator is not particularly limited, and may be made of a resin such as polyethylene (PE), polypropylene (PP), polyester, or polyamide. The separator may have a single-layer structure or a multilayer structure. Examples of separators having a multi-layer structure include a separator having a two-layer structure of PE/PP, and a separator having a three-layer structure of PP/PE/PP or PE/PP/PE. The separator may be made of a nonwoven fabric such as a cellulose nonwoven fabric, a resin nonwoven fabric, or a glass fiber nonwoven fabric.

### Bipolar Electrode Stack

The bipolar electrode stack may include a current collector layer, a cathode active material layer, and an anode active material layer.

### Current Collector Layer

The material used for the current collector layer is not particularly limited. However, the current collector layer may be made of, for example, a metal foil or metal mesh. Examples of materials that can be used for the current collector layer include, but are not limited to, Cu, Ni, Cr, Au, Pt, Ag, Al, Fe, Ti, Zn, Co, stainless steel, or a carbon sheet. The current collector layer may have a coating layer on its surface for purposes such as adjusting resistance.

The thickness of the current collector layer is not particularly limited, but may be 0.1 μm or more, or 1 μm or more, and may be 1 mm or less, or 100 μm or less.

### Cathode Active Material Layer

The cathode active material layer contains at least a cathode active material, and may further contain, optionally, a solid electrolyte, a conductive additive, a binder, etc. The cathode active material layer may also contain various additives. The respective contents of the cathode active material, the solid electrolyte, the conductive additive, the binder, etc. in the cathode active material layer may be determined as appropriate in accordance with the intended battery performance. For example, when the entire cathode active material layer (total solid content) is taken as 100 mass %, the content of the cathode active material may be 40 mass % or more, 50 mass % or more, or 60 mass % or more, and may be 100 mass % or less, or 90 mass % or less.

The cathode active material is not particularly limited as long as it can store and release lithium ions. Examples of the cathode active material include, but are not limited to, lithium cobalt oxide (LiCoO₂), lithium nickel oxide (LiNiO₂), lithium manganese oxide (LiMn₂O₄), lithium nickel cobalt manganese oxide (NCM: LiCO_{1/3}Ni_{1/3}Mn_{1/3}O₂), lithium nickel cobalt aluminum oxide (LiNi_{0.8}(CoAl)_{0.2}O₂), and a hetero-element-substituted Li-Mn spinel having a composition represented by Li₁₊ₓMn_{2-x-y}M_{y}O₄ (where M is one or more metal elements selected from Al, Mg, Co, Fe, Ni, and Zn).

The cathode active material is not particularly limited, but may have a coating layer. The coating layer contains a substance that has lithium-ion conduction properties, exhibits low reactivity with the cathode active material and the solid electrolyte, and is capable of maintaining the form of a coating layer that does not flow even in contact with the active material or the solid electrolyte. Specific examples of materials of the coating layer include, but are not limited to, LiNbO₃, Li₄Ti₅O₁₂, and Li₃PO₄.

The shape of the cathode active material is not particularly limited as long as it is a shape generally used for cathode active materials in batteries. The cathode active material may be, for example, in the form of particles. The cathode active material may be primary particles, or may be secondary particles formed by aggregation of multiple primary particles. The average particle size D₅₀ of the cathode active material may be, for example, 1 nm or more, 5 nm or more, or 10 nm or more, and may be 500 μm or less, 100 μm or less, 50 μm or less, or 30 μm or less. The average particle size D₅₀ is defined as the particle size (median diameter) corresponding to 50% of the volume-based cumulative particle size distribution as determined by a laser diffraction and scattering method.

The material of the solid electrolyte is not particularly limited, and may be, for example, a sulfide solid electrolyte, an oxide solid electrolyte, or a polymer electrolyte.

Examples of sulfide solid electrolytes include, but are not limited to, sulfide-based amorphous solid electrolytes, sulfide-based crystalline solid electrolytes, and argyrodite-type solid electrolytes. Specific examples of sulfide solid electrolytes include, but are not limited to, Li₂S—P₂S₅-based electrolytes (e.g., Li₇P₃S₁₁, Li₃PS₄, and Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (e.g., Li₁₃GeP₃S₁₆ and Li₁₀GeP₂S₁₂), LiI—Li₂S—P₂O₅, LiI—Li₃PO₄—P₂S₅, Li₇₋ₓPS₆₋ₓClₓ, and combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ (LiPON), and combinations thereof.

The sulfide solid electrolyte and the oxide solid electrolyte may be either glass or crystallized glass (glass ceramic).

Examples of polymer electrolytes include, but are not limited to, polyethylene oxide (PEO), polypropylene oxide (PPO), and copolymers thereof.

The conductive additive is not particularly limited. Examples of conductive additives include, but are not limited to, vapor-grown carbon fibers (VGCFs), acetylene black (AB), Ketjen black (KB), carbon nanotubes (CNTs), and carbon nanofibers (CNFs). The conductive additive may be, for example, in the form of particles or fibers, and its size is not particularly limited. A single type of conductive additive may be used alone, or two or more types may be used in combination, but the conductive additive is not limited to these.

The binder is not particularly limited. Examples of binders include, but are not limited to, polyvinylidene fluoride (PVdF), butadiene rubber (BR), polytetrafluoroethylene (PTFE), and styrene-butadiene rubber (SBR). A single type of binder may be used alone, or two or more types may be used in combination, but the binder is not limited to these.

The shape of the cathode active material layer is not particularly limited. However, the cathode active material layer may be, for example, in the form of a sheet having a substantially flat surface. The thickness of the cathode active material layer is not particularly limited, but may be, for example, 0.1 μm or more, 1 μm or more, or 10 μm or more, and may be 2 mm or less, 1 mm or less, or 500 μm or less.

The cathode active material layer can be produced by applying a known method. For example, the cathode active material layer can be easily formed by molding a cathode mixture containing the above components by a dry or wet method. The cathode active material layer may be molded together with the current collector layer, or may be molded separately from the current collector layer.

### Anode Active Material Layer

As the anode active material, various substances can be employed that have a potential (charge/discharge potential) more negative than that of the above cathode active material of the present disclosure. The anode active material is not particularly limited, and may be lithium metal, or a material capable of storing and releasing metal ions such as lithium ions. Examples of materials capable of storing and releasing metal ions such as lithium ions include, but are not limited to, alloy-based anode active materials, carbon materials, and lithium titanate (Li₄Ti₅O₁₂).

The alloy-based anode active materials are not particularly limited, and examples thereof include Si-alloy-based anode active materials and Sn-alloy-based anode active materials. Examples of the Si-alloy-based anode active materials include silicon, silicon oxides, silicon carbides, silicon nitrides, and solid solutions thereof. The Si-alloy-based anode active materials may also contain metal elements other than silicon, such as Fe, Co, Sb, Bi, Pb, Ni, Cu, Zn, Ge, In, Sn, and Ti. Examples of the Sn-alloy-based anode active materials include tin, tin oxides, tin nitrides, and solid solutions thereof. The Sn-alloy-based anode active materials may also contain metal elements other than tin, such as Fe, Co, Sb, Bi, Pb, Ni, Cu, Zn, Ge, In, Ti, and Si.

The carbon materials are not particularly limited, and examples thereof include hard carbon, soft carbon, and graphite.

The shape of the anode active material is not particularly limited as long as it is a shape generally used for anode active materials in batteries. The anode active material may be, for example, in the form of particles or a sheet.

Regarding the solid electrolyte, conductive additive, and binder that may be contained in the anode active material layer, reference can be made to the above description of the cathode active material layer.

The shape of the anode active material layer is not particularly limited. However, the anode material layer may be, for example, in the form of a sheet having a substantially flat surface. The thickness of the anode active material layer is not particularly limited, but may be, for example, 0.1 μm or more, 1 μm or more, or 10 μm or more, and may be 2 mm or less, 1 mm or less, or 500 μm or less.

The anode active material layer can be produced by applying a known method. For example, the anode active material layer can be easily formed by molding an anode mixture containing the above components by a dry or wet method. The anode active material layer may be molded together with the current collector layer, or may be molded separately from the current collector layer.

### Method for Inspecting Energy Storage Module

A method for inspecting an energy storage module according to the present disclosure includes:
setting an odd-numbered electrolyte chamber and an even-numbered electrolyte chamber counted from the lower side in the stacking direction of the bipolar electrode stacks to different internal pressures; and
detecting either or both of entry of gas or liquid in the even-numbered electrolyte chamber into one or more of the odd-numbered electrolyte chambers and entry of gas or liquid in the odd-numbered electrolyte chamber into one or more of the even-numbered electrolyte chambers.

The present disclosure thus provides an inspection method that enables rapid sealing inspection of electrolyte chambers.

Hereinafter, of the odd-numbered and even-numbered electrolyte chambers, the one having the higher internal pressure will be referred to as the first electrolyte chamber, and the one having the lower internal pressure will be referred to as the second electrolyte chamber. Accordingly, the odd-numbered electrolyte chamber may be the first electrolyte chamber and the even-numbered electrolyte chamber may be the second electrolyte chamber, or vice versa.

The method for inspecting an energy storage module according to the present disclosure includes setting an odd-numbered electrolyte chamber and an even-numbered electrolyte chamber counted from the lower side in the stacking direction of the bipolar electrode stacks to different internal pressures.

The difference in internal pressure between the first electrolyte chamber and the second electrolyte chamber is preferably 10 kPa or more, 20 kPa or more, 30 kPa or more, 40 kPa or more, or 50 kPa or more, from the standpoint of detecting inter-chamber leak and/or injection-connector leak. The difference in internal pressure may be 100 kPa or less, 90 kPa or less, 80 kPa or less, 70 kPa or less, or 60 kPa or less. The internal pressures of the first electrolyte chamber and the second electrolyte chamber are not particularly limited, and may be determined as appropriate in view of the difference in internal pressure between the first and second electrolyte chambers, the pressure resistance performance of the energy storage module, the external atmospheric pressure, etc.

The difference in internal pressure between the first electrolyte chamber and the second electrolyte chamber may be adjusted by adjusting the internal pressure of either one of the electrolyte chambers, or by adjusting the internal pressures of both.

The internal pressures of the first and second electrolyte chambers may be adjusted by pressurization or by depressurization. The method for adjusting the internal pressures is not particularly limited. For example, the internal pressures of the electrolyte chambers may be adjusted by connecting a pump, a compressor, or the like to the injection connector and operating it. The method for adjusting the internal pressures is not limited to injecting or drawing in air, and may involve injecting or drawing in other gases or liquids. It is preferable from the standpoint of improving the efficiency of the sealing inspection that the internal pressure adjustment of the first electrolyte chambers and the second electrolyte chambers be performed simultaneously.

The method for inspecting an energy storage module according to the present disclosure includes detecting either or both of entry of gas or liquid in the even-numbered electrolyte chamber into one or more of the odd-numbered electrolyte chambers and entry of gas or liquid in the odd-numbered electrolyte chamber into one or more of the even-numbered electrolyte chambers.

The internal pressure of the first electrolyte chamber is higher than that of the second electrolyte chamber. Accordingly, when there is a flow path between the first electrolyte chamber and the second electrolyte chamber, gas or liquid in the first electrolyte chamber flows into the second electrolyte chamber.

The liquid and gas are not particularly limited. The liquid may be, for example, the electrolyte to be enclosed when the energy storage module is used as a bipolar battery. The gas may be, for example, air, hydrogen, helium, or argon.

The method for detecting the entry of gas or liquid is not particularly limited. For example, a detector may be connected to the injection connector to detect gas or liquid that has flowed into the second electrolyte chamber. When the substance expected to flow into the electrolyte chamber is hydrogen, helium, or argon, the entry of the substance into the electrolyte chamber may be detected by a hydrogen leak detector, a helium leak detector, or an argon leak detector, respectively. The entry of gas or liquid may alternatively be detected by measuring a change in the internal pressure of the first electrolyte chamber and/or the second electrolyte chamber. The change in internal pressure may be detected by connecting a pressure sensor, a pressure gauge, or the like to the injection connector, sealing the electrolyte chamber, and measuring the internal pressure before and after the internal pressure adjustment.

When the entry of gas or liquid is detected, it may be determined that there is an abnormality in at least one of sealing between adjacent ones of the electrolyte chambers, sealing between adjacent ones of the injection flow paths of the injection connector, or sealing between the injection connector and the frame-shaped sealing portion.

When entry of gas or liquid in the first electrolyte chamber into one or more second electrolyte chambers is detected, it may be determined that inter-chamber leak has occurred between the second electrolyte chamber and the first electrolyte chamber adjacent to the second electrolyte chamber in the stacking direction, and/or that injection-connector leak has occurred between the second electrolyte chamber and the first electrolyte chamber having an injection hole adjacent to the second electrolyte chamber in the stacking direction.

When detection of entry of gas or liquid is performed using a detector, the detection threshold used to determine an abnormality is not particularly limited, and may be determined as appropriate in view of the difference in internal pressure between the first and second electrolyte chambers, the type of gas or liquid, the detection limit of the detector, etc.

When detection of entry of gas or liquid is performed based on a change in internal pressure, the threshold of the change in internal pressure used to determine an abnormality is not particularly limited, and may be determined as appropriate in view of the difference in internal pressure between the first and second electrolyte chambers, the inspection time, etc. For example, the change in internal pressure may be 50 Pa or more, 100 Pa or more, or 200 Pa or more. The inspection time refers to the period from when the internal pressures of the first and second electrolyte chambers are adjusted and sealed until the change in internal pressure is measured. The inspection time is not particularly limited, and may be, for example, 50 seconds or more, 100 seconds or more, or 200 seconds or more.

What is claimed is:

1. An energy storage module comprising:
a plurality of bipolar electrode stacks;
a plurality of frame-shaped sealing portions; and
an injection connector, wherein:
the energy storage module includes a plurality of electrolyte chambers, each provided by a corresponding pair of the bipolar electrode stacks adjacent to each other in a stacking direction of the bipolar electrode stacks and the frame-shaped sealing portion interposed between the pair of bipolar electrode stacks;
each of the electrolyte chambers has an injection hole provided in a respective one of the frame-shaped sealing portions;
the injection holes are arranged in an array of a plurality of rows in the stacking direction and a plurality of columns in an in-plane direction, and each of the injection holes is in communication with a respective one of a plurality of injection flow paths of the injection connector; and
for an m-th electrolyte chamber and an n-th electrolyte chamber counted from a lower side in the stacking direction, there is at least one combination of m and n that satisfies following conditions:
(i) the injection hole of the n-th electrolyte chamber is disposed adjacent to an upper side, in the stacking direction, of the injection hole of the m-th electrolyte chamber; and
(ii) when m is odd, n is even, and when m is even, n is odd.

2. The energy storage module according to claim 1, wherein, for a p-th electrolyte chamber and a q-th electrolyte chamber counted from the lower side in the stacking direction of the bipolar electrode stacks, there is at least one combination of p and q that satisfies following conditions:
(i) the injection hole of the p-th electrolyte chamber is disposed adjacent to a left side, in the in-plane direction, of the injection hole of the q-th electrolyte chamber; and
(ii) when p is odd, q is even, and when p is even, q is odd.

3. The energy storage module according to claim 1, wherein the number of columns of the injection holes arranged in the in-plane direction is even.

4. A method for inspecting the energy storage module according to claim 1, the method comprising:
setting an odd-numbered electrolyte chamber and an even-numbered electrolyte chamber counted from the lower side in the stacking direction of the bipolar electrode stacks to different internal pressures; and
detecting either or both of entry of gas or liquid in the even-numbered electrolyte chamber into one or more of the odd-numbered electrolyte chambers and entry of gas or liquid in the odd-numbered electrolyte chamber into one or more of the even-numbered electrolyte chambers.

5. The method according to claim 4, wherein, when the entry is detected, determination is made that there is an abnormality in at least one of sealing between adjacent ones of the electrolyte chambers, sealing between adjacent ones of the injection flow paths of the injection connector, or sealing between the injection connector and the frame-shaped sealing portion.
